(19) United States
(12) Patent Application Publication
(10) Pub. No.: US 2026/0228535 A1
(43) Pub. Date: Aug. 6, 2026

(54) SAMPLE BROADENING USING LLM-DIFF TO EXPAND ACTIVE LEARNING STRATEGIES

(71) Applicant: Bytedance Technology Ltd., Grand Cayman (KY)

(72) Inventors: Yu Sun, Los Angeles, CA (US); Hongyu Xiong, Culver City, CA (US); Ruixiao Sun, Los Angeles, CA (US); Linjie Wang, Los Angeles, CA (US)

(21) Appl. No.: 19/046,258

(22) Filed: Feb. 5, 2025

(51) Int. Cl. G06N 3/0895

(52) U.S. Cl. CPC G06N 3/0895

(57) ABSTRACT

Implementations for sample broadening techniques using large language model-based filtering to expand active learning strategies are provided. One implementation provides a computing system comprising: processing circuitry and memory storing instructions that, when executed, cause the processing circuitry to: receive a plurality of unlabeled data samples; determine a plurality of seed cases; for each of the seed cases, identify a subset of the unlabeled data samples that is semantically similar to the seed case; identify one or more of the unlabeled data samples having a prediction score difference above a predetermined threshold using a large language model; annotate the subsets of the unlabeled data samples and the one or more of the unlabeled data samples to generate a labeled dataset; and train the machine learning model using the labeled dataset.

### BACKGROUND

Active learning is a machine learning technique that aims to optimize the annotation process by minimizing the amount of labeled data needed for training. Generally, active learning is particularly beneficial in situations where labeling data is expensive and/or time-consuming. The process involves training an initial model on a labeled dataset. For further tuning and training, the model utilizes a pool of data that is initially unlabeled. Human labeling of the entire pool may be prohibitively expensive. As such, active learning techniques can be employed to strategically identify and select the most informative data points or data samples from the pool. The selected data samples are then labeled, either through human annotation or an automated labeling process that is relatively computationally expensive. The model can then be trained with the newly labeled data. This training paradigm allows the model to learn more efficiently and achieve higher accuracy with less labeling effort. Many different strategies exist for the selection of data points in the active learning process, including statistical-based methodologies.

### SUMMARY

Implementations for sample broadening techniques using large language model-based filtering to expand active learning strategies are provided. One implementation provides a computing system comprising: processing circuitry and memory storing instructions that, when executed, cause the processing circuitry to: receive a plurality of unlabeled data samples; determine a plurality of seed cases; for each of the seed cases, identify a subset of the unlabeled data samples that is semantically similar to the seed case; identify one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model; annotate the subsets of the unlabeled data samples and the one or more of the unlabeled data samples to generate a labeled dataset; and train the machine learning model using the labeled dataset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system 100 for implementing sample broadening using large language model score differences to expand active learning strategies.

FIG. 2 shows a data flow diagram of an active learning pipeline utilizing an embedding k-nearest neighbor algorithm and large language model-based filtering, which can be implemented using the example computing system of FIG. 1.

FIG. 3 shows a data flow diagram of a simplified active learning pipeline for utilizing large language model-based filtering, which can be implemented using the example computing system of FIG. 1.

FIG. 4 shows a table comparing various data selection strategies.

FIG. 5 shows a process flow diagram of an example method for implementing sample broadening using large language model-based filtering to expand active learning strategies, which can be implemented using the example computing system of FIG. 1.

FIG. 6 shows a schematic view of an example computing system that can enact one or more of the methods and processes described herein.

### DETAILED DESCRIPTION

In modern search systems, a search relevance model (SRM) is generally utilized for calculating the relevance score between a user's search query and candidate items (e.g., videos or feeds). The model typically predicts a relevancy score with multi-class probabilities. For instance, some search systems employ a multi-modality transformer model that is trained on multi-class annotated data, suggesting “completely irrelevant,” “slightly relevant,” “moderately relevant,” “highly relevant,” etc. for a given query video pair.

Annotated data provides the foundation for training many different types of machine learning (ML) models, including content understanding models and search relevance models such as those described above. For example, online search platforms utilize search relevance models to optimize the relevancy of items selected for a given query. The training and evaluation of these models are generally reliant on manually annotated data. Oftentimes, there is desire to curate which data samples from an unlabeled data pool are to be selected for annotation/labeling and training. Labeling the entire pool of data may be infeasible or undesirable. For example, in some cases, manual annotation of data can be prohibitively expensive, either due to a lack of resources or high annotation costs. In other cases, there is simply a desire to train efficiently on informative data samples that would likely increase performance of the model.

Many different annotation pipelines exist for selecting data samples for labeling. Annotation pipelines based on random sampling often lead to a lack of effectiveness in model training. Non-random sampling methodologies have also been contemplated. One class of methodologies includes active learning (AL) strategies, which attempts to improve annotation efficiency by prioritizing informative data samples for labeling, making model training more effective. Typically, informative data samples are difficult data samples where the model prediction confidence is low. In other words, an AL strategy can be utilized to proactively identify one or more data samples from an unlabeled data pool that may be difficult for the model to process accurately—i.e., likely to result in an incorrect output.

Active learning strategies generally employ statistical methodologies to identify and prioritize informative data samples (e.g., difficult data samples). Conventional statistical-based AL strategies filter samples based on the confidence patterns of multi-class output probabilities. Three examples of such include a least confident metric (Eq 1), a margin sampling metric (Eq 2), and an N-best sequence entropy (NSE) metric (Eq 3). These statistical methods focus on uncertainty sampling where the model exhibits low confidence, inferred from close probabilities among classes or high entropy in the output distribution.

$${Φ}^{LC} ( x ) = 1 - P ( y * \vert x ; θ ) \qquad ( 1 )$$

$${Φ}^{M} ( x ) = - ( P ( {y}_{1}^{*} \vert x ; θ ) - P ( {y}_{2}^{*} \vert x ; θ ) ) \qquad ( 2 )$$

$${Φ}^{NSE} ( x ) = - {\sum }_{\hat{y} ∈ 𝒩} P ( \hat{y} \vert x ; θ ) log P ( \hat{y} \vert x ; θ ) \qquad ( 3 )$$

Statistical active learning (SAL) can improve annotation efficiency by prioritizing difficult samples for labeling, making model training more effective. However, conventional active learning strategies relying on probability score statistics for multi-class classification problems are generally dependent on the pretraining of natural language processing (NLP) base models and fine-tuned samples. This limits the model's generalization capabilities and makes it difficult to generalize to content and entities the model has never trained on before. Additionally, the volume of human annotations is inherently constrained, meaning that only a subset of sampled data can undergo human annotation. This constraint makes it difficult for training data to fully capture the rapidly evolving trends in content, especially on social media platforms where users frequently encounter highly dynamic changes, such as new products, buzzwords, and/or brands. Accordingly, there is a need to expand the AL strategies' capabilities to include less-represented and non-represented samples.

In view of the observations above, implementations of sample broadening using large language model (LLM) score differences to expand active learning strategies are provided. The present disclosure provides a novel sample broadening technique that can be used additionally or alternatively to various AL strategies for implementation on a machine learning model, such as a content understanding model and/or a search relevancy model. For example, the sample broadening techniques described herein can be implemented along with an AL strategy based on latent space broadening (LSB). In some implementations, LSB is implemented through a k-nearest-neighbor (kNN) algorithm that identifies neighbors of seed cases in latent space, which is based on the hidden state embedding from the model. Similar cases whose hidden embeddings are similar to seed cases are selected. To expand the model's generalization capabilities to generalize to new and evolving content, the techniques described herein leverage the capabilities of pre-trained LLMs to help identify informative cases that the previous training data failed to cover. Without the productivity constraints of human annotation, LLMs can be used at scale to score a vast amount of data in a zero-shot or supervised fine-tuning (SFT) manner and identify cases where relevance model predictions significantly diverge from the scores provided by the LLMs.

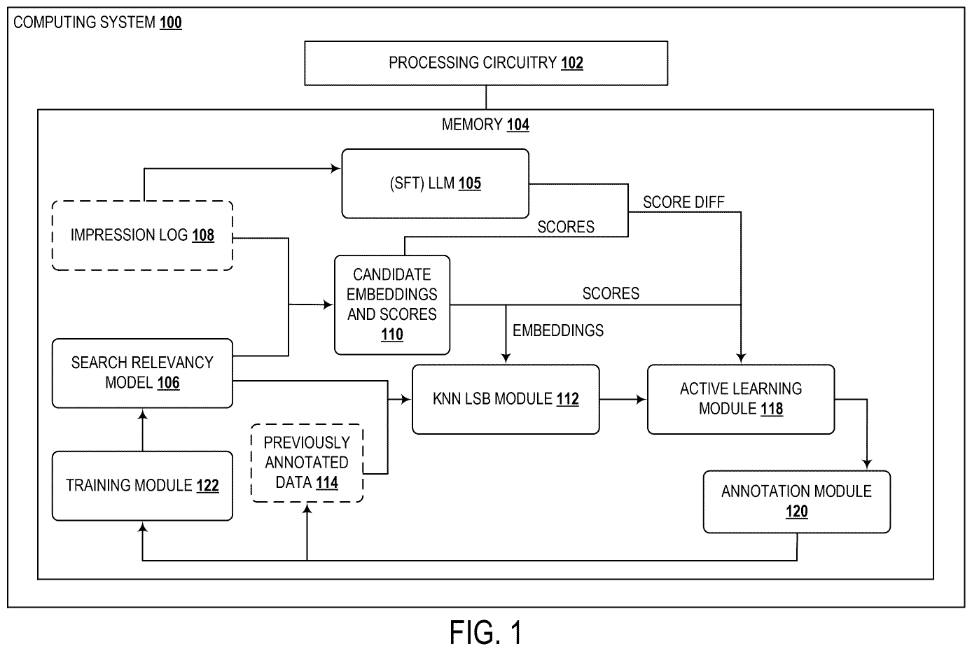

Turning now to the drawings, implementations of sample broadening using LLM score differences to expand active learning strategies are depicted and described in further detail. FIG. 1 shows a schematic view of an example computing system 100 for implementing sample broadening using LLM-based filtering to expand active learning strategies. The example computing system 100 includes processing circuitry 102 and memory 104 storing instructions that, during execution, cause the processing circuitry 102 to perform the processes described herein. The example computing system 100 can be implemented with one or more of various types of computing devices, including but not limited to personal computers, servers, and mobile devices. For example, the computing system 100 can include a plurality of computing devices, and processing circuitry 102 and memory 104 may each include multiple components spread across multiple computing devices (e.g., processing circuitry 102 can include multiple processors within a single device or spread across multiple devices). The devices may be locally and/or remotely located. The example computing system 100 can also include non-depicted components for providing various functionalities, including components on individual computing devices.

The example computing system 100 implements a pipeline for data annotation using an AL strategy with LSB. The pipeline also includes the use of LLM-based filtering using an LLM 105. As described above, the use of LLM-based filtering with score differences can be applied in combination with various AL strategies (e.g., the system of FIG. 1) or used as an alternative to such strategies for sample broadening. In the depicted example, the pipeline is implemented for a search relevancy model 106. To ease of discussion, the techniques discussed in this disclosure may sometimes be described in the context of a specific machine learning model or machine learning framework. However, such techniques may be applied to any other type of machine learning model and/or framework. For example, FIG. 1 describes an AL strategy in the context of training a search relevancy model. As can readily be appreciated, such techniques can be applied to other machine learning models that utilize/train on annotated data. In some implementations, the pipeline provides annotated data for training a content understanding model. In some implementations, the pipeline provides annotated data for training an online BERT model.

The pipeline starts with receiving unlabeled data. In the depicted example, the pipeline includes accessing data from an online stream recorded in an impression log 108. The impression log 108 can be implemented in various ways. In some implementations, the impression log 108 records live data from an online search system of a social media platform. The impression log 108 provides a pool of unlabeled data that that can be utilized for the AL pipeline, including data annotation and model training steps. The unlabeled data can include different content and be of various formats depending on the model being implemented. For example, in the context of an online search system of a social media platform, the unlabeled data can be in form of query-video pairs.

Utilizing the search relevancy model 106, data from the impression log 108 are processed to extract and generate latent embeddings and scores 110 for candidate data samples/candidate unlabeled pairs. The latent embeddings and/or scores 110 can represent different aspects depending on the unlabeled data samples. For example, for query-video pairs, latent embeddings can describe features of the video (e.g., content, theme, length, format, etc.). Scores can describe a relevancy score between the query and the video (e.g., “completely irrelevant,” “slightly relevant,” “moderately relevant,” “highly relevant,” etc.) and a corresponding confidence level of the relevancy score. Generally, the candidate data samples are unlabeled data that the pipeline identified as being informative to the training of the search relevancy model 106. For example, conventional AL strategies often attempt to find candidate unlabeled data based on statistical methods, usually identifying data samples with scores having low confidence levels. In the depicted example, the pipeline can use any criteria to identify the candidate data samples, including similar statistical methodologies described above (e.g., a least confident metric, a margin sampling metric, etc.).

The pipeline includes a kNN LSB module 112 for selecting K similar informative data samples. The kNN LSB module 112 utilizes the latent embeddings from the candidate data samples along with a set of seed cases (i.e., seed data samples/seed data pairs) to identify which of the candidate data samples are semantically similar to the seed cases. The set of seed cases can include one or more cases. Generally, the seed cases are selected from annotated data pairs that are identified as “bad” cases. “Bad” refers to a discrepancy in the model's predicted score and the data's annotation. Various criteria can be implemented for selecting bad cases. In some implementations, seed cases are identified as a predetermined number of cases with the largest discrepancy between annotations and model predictions among a set of annotated data samples. In the depicted example, the seed bad cases are selected from previously annotated data 114, such as data annotated by the pipeline in a previous process. The kNN LSB module 112 can utilize the search relevancy model 106, comparing the model's predictions to the previously annotated data 114 to determine bad cases. In some implementations, the previously annotated data 114 includes data annotated by the pipeline within a timeframe. For example, the previously annotated data 114 can include data that was annotated the day before the current iteration of the pipeline.

The kNN LSB module 112 extracts latent embeddings and generates scores from the set of seed bad cases. Through a kNN algorithm, the kNN LSB module 112 selects one or more of the candidate data samples based on their latent embeddings and their similarity to the seed bad cases. In some implementations, the kNN LSB module 112 ranks and selects K of the candidate data samples 110 based on the ranking. The kNN algorithm can be implemented in various ways. In some implementations, the kNN algorithm selects the candidate data samples 110 by calculating similarity between their latent embeddings and the latent embeddings of the seed bad cases in latent space.

The pipeline utilizes the LLM 105 to perform LLM-based filtering using differences between scores produced by the LLM 105 and scores produced by the search relevancy model 106. Various types of LLMs can be utilized. In some implementations, the LLM 105 is a decoder-only LLM. Such LLMs are typically implemented with a large number of parameters (e.g., more than 1 billion parameters). Unlike encoder-only models, which generally focus on understanding tasks, a decoder-only LLM can excel in few-shot or zero-shot learning, solving diverse tasks without task-specific training. In some cases, supervised fine-tuning can be performed on a pre-trained LLM on a specific labeled dataset to adapt it to a particular task or domain, improving its performance in that context. In other cases, a pre-trained LLM can be used to perform tasks without any additional fine-tuning or task-specific training, relying solely on its general knowledge and capabilities.

In the depicted example of FIG. 1, the LLM 105 is an SFT decoder-only LLM that can identify cases where predictions differ from the model's predictions. The LLM 105 receives the data samples from the impression log 108 and queries it for relevancy. The output is compared to the candidates' scores, and the score difference is used to filter out cases. In some implementations, if the score difference is above a predetermined threshold, further analysis can be conducted. The LLM 105 can, for example, analyze the proportion of over—and under-estimations, as well as the bad-case ratio among the selected cases. Samples with prediction discrepancies between the decoder-only LLM 105 and the search relevancy model 106 above the predetermined threshold can be prioritized for annotation. This approach enables the search relevancy model 106 to continuously absorb the generalization capabilities of the decoder-only LLM 105, particularly in terms of adapting to dynamic trends.

Information from the candidate data samples, the kNN LSB module 112, and the score differences from the LLM 105 are used in combination by an active learning module 118 configured to merge said information, such information describing which kNN-selected data samples were filtered. The resulting data samples are then sent to an annotation module 120 for data annotation. The data can be annotated in various ways, including through manual human annotation. In some implementations, the data is annotated through an automated process, such as through use of another machine learning model. The annotated data is then utilized by a training module 122 for training of the search relevancy model 106.

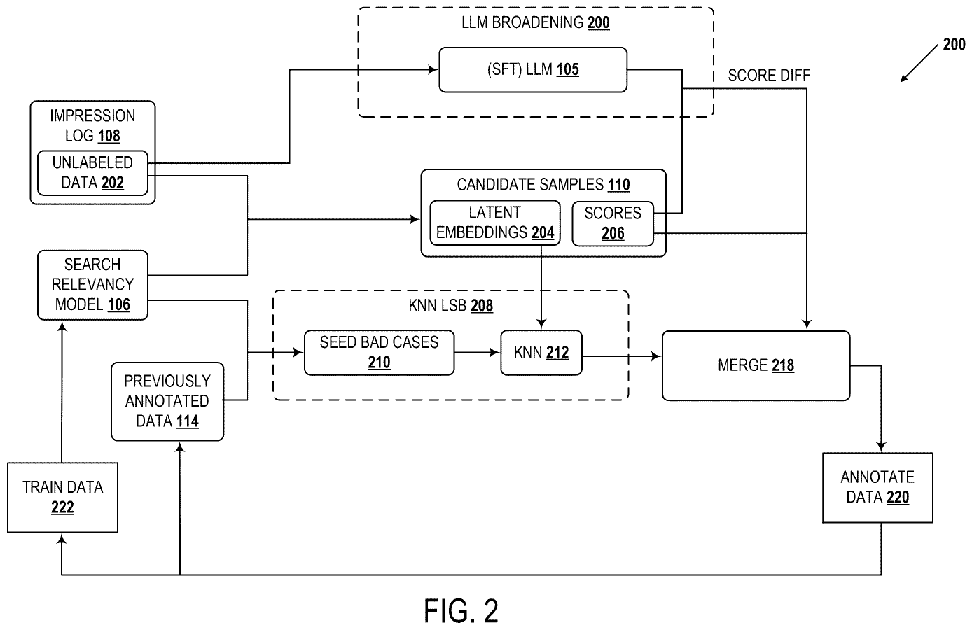

FIG. 1 depicts and describes an example pipeline for data annotation. As can readily be appreciated, the idea of combining an embedding kNN algorithm along with LLM-based filtering can be expanded to other settings and context. A logical data flow pipeline of such is described in more detail in FIG. 2.

FIG. 2 shows a data flow diagram of an active learning pipeline 200 utilizing an embedding k-nearest neighbor algorithm and LLM-based filtering. In the depicted example, the pipeline 200 is performed in conjunction with a search relevancy model 106. The search relevancy model 106 can be implemented using various architectures. In some implementations, the search relevance model employs a BEIT3-like architecture that adopts a multi-expert bi-directional transformer to handle multi-modal input—e.g., query and video frames. During the serving stage, the search relevancy model 106 first takes video frames as input and converts them to visual tokens under the same vision-language (VL) representation space. The search relevancy model 106 then integrates both visual and textual tokens for relevancy prediction.

The search relevancy model 106 can be configured in various ways to convert video frames into visual tokens. In some implementations, visual token projection is performed utilizing a vision layer g(·; θ). For the sequence of sampled frames with length T, the raw input X_{f} is passed through a vision layer g(·; θ) that extracts its visual features and projects them to a modality-aligned representation space:

$${H}_{f}^{( i )} = g ( {X}_{f}^{( i )} ; θ ) \qquad ( 4 )$$

where i=1, 2, . . . , T, and H_{f} serves as the sequence of visual tokens, facilitating downstream integration with textual tokens. A VL fused layer can then be implemented to process a sequence of both visual tokens H_{f} and text tokens Xₜ (e.g., query, the video's textual information, etc.). In some implementations, a VL fused transformer Vlmo(·; θ) is utilized. The transformer Vlmo(·; θ) takes the multi-modal tokens as input and generates a sequence of hidden representations H where each representation corresponds to an input token, maintaining the same sequence length as the input sequence.

$$H = Vlmo ( [ {H}_{f} ; {X}_{t} ] ; θ ) \qquad ( 5 )$$

A classification module far (·; θcl) can be applied on top of the hidden state embedding H_{cls} of the [CLS] token (classification token). In some implementations, the classification module includes a multilayer perceptron (MLP) mapping H_{cls}∈R^{d} to R^{|Y|}, where Y is the set of target classes.

The search relevancy model 106 as described above can be utilized by the pipeline in determining informative data samples in accordance with an AL strategy. The pipeline 200 starts by identifying a set of candidate data samples 110 from a pool of unlabeled data 202 sampled from an impression log 108 of the online service attached to the search relevancy model 106. In the depicted example, latent embeddings 204 and relevancy scores 206 along with confidence level information is acquired for the set of candidate data samples 110 using the search relevancy model 106. From this set of candidate data samples 110, the pipeline 200 includes a kNN LSB process 208 that selects a number of data samples based on their similarity to seed cases.

Similar to FIG. 1, the seed cases utilized in the pipeline 200 of FIG. 2 are seed “bad” cases 210. “Bad” cases can include data samples where the model's predicted relevancy score is misaligned (e.g., above a predetermined threshold) with annotations, including human annotations. Seed bad cases 210 can be selected in various ways. In some implementations, a predetermined number of top bad cases (cases with the largest discrepancy between manual annotations and model predications) are selected as the seed bad cases 210. Different sources can be used to provide an initial pool of cases from which the seed bad cases 210 can be selected. The pipeline 200 depicted in FIG. 2 can be utilized to manage daily annotations in a recurrent manner, updating the AL sampling details based on annotations and the search relevancy model 106 from the last snapshot. In the depicted example, the seed bad cases 210 are provided by previously annotated data 114. For example, data that was annotated in a previous predetermined length of time (e.g., the previous day) can be utilized as the seed bad cases 210. In some implementations, from the most recent date partitions of the impression log 108 (e.g., the last 30 days), cases are sorted based on the differences between the annotated labels and the predicted scores of the model 106. The CLS hidden embeddings and the final multi-class vectors of the corresponding query-video pairs can be cached for further analysis and improvement.

The kNN LSB process 208 expands on the seed bad cases 210 through latent space broadening. In the depicted example, the pipeline utilizes a kNN algorithm 212 to select cases whose hidden embeddings are similar to those of the seed bad cases 210. The kNN algorithm 212 facilitates the identification of similar cases to the seed bad cases 210 by calculating similarity between embeddings in latent space. This enables the preservation of linguistic and semantic information between the query-item pair. For ease of discussion, h is used herein to simplify H_{cls}. Based on the final classification module (usually a two-layer MLP) of the search relevancy model 106:

$$\hat{y} = f ( h ; W ) = softmax ( W \cdot h ) \qquad ( 6 )$$

where, for any h′ that belongs to kNN of h, it is expected that under a certain limit ∈, s.t. ∥h′−h∥≤ε, there would be ∥ŷ′−ŷ∥≤δ, s.t. within δ-vicinity of ŷ, ŷ′ would give the same output class of output=argmaxᵢŷ. However, due to the non-linearity nature of f(h; W), it is difficult for the kNN algorithm 212 to explicitly guarantee that h and h′ are close enough in the latent space. In addition, even though for a certain h′ the δ-vicinity can be guaranteed, its actual label l′=idx(y′) could be different from the label l=idx(y) of h—i.e. two pairs of query-videos could be semantically close, but with different scores (e.g., one is “slightly relevant” but the other is “moderately relevant”). In this situation, expansion of bad cases is limited.

The pipeline 200 also includes an LLM broadening process 214 that can include data samples with content that the model 106 has not previously seen or finds difficult to generalize. For example, the volume of human annotations is generally constrained, making it difficult to utilize all available sampled data. This constraint makes training data nearly impossible to fully represent the rapidly evolving trends of content, especially on social media platforms where users experience highly dynamic trending changes, such as new products, new buzzwords, or new brands. Therefore, it is difficult for the model 106 to generalize on entities or content it has not seen. The pipeline 200 utilizes a pre-trained LLM 105 to help discover bad cases previous training data missed to cover, in a scaled manner. Furthermore, without the productivity constraints for human annotation, the LLM 105 can be used to score a huge volume of data in a zero-shot way and identify cases where model predictions significantly diverge from scores provided by LLM 105. The LLM 105 processes the unlabeled data 202 to determine whether the sample is relevant. This score is compared with the scores 206 of the candidate samples 110 to generate score differences that can be used to prioritize cases with prediction discrepancies for annotation.

After calculating the score differences, the pipeline 200 then merges 218 information from various points in the pipeline 200 to provide a list of data samples (e.g., query-video pairs) for annotation 220. The annotation can be performed in various ways, including through human efforts and/or through automated processes. The annotated data is then provided for training 222 of the search relevancy model 106.

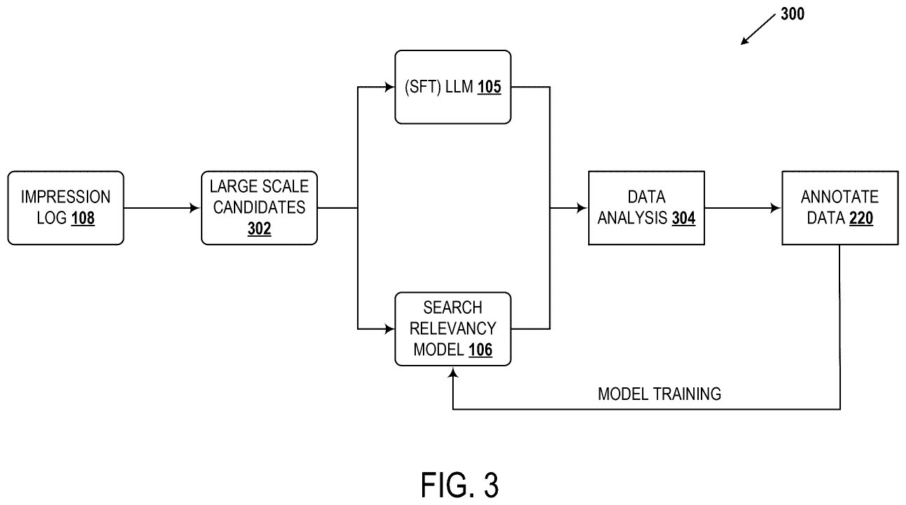

FIGS. 1 and 2 illustrate example pipelines utilizing LLM-based filtering in combination with kNN algorithms for expanding active learning strategies. However, such techniques can also be applied independently of the LSM-kNN expansion techniques. FIG. 3 shows a data flow diagram of a simplified active learning pipeline 300 for utilizing large language model-based filtering. The pipeline 300 starts with retrieving samples from an impression log 108. As the LLM-based filtering technique can be applied at scale, a large number of samples can be retrieved, forming a large-scale pool of candidate samples 302. An LLM 105 and the online model 106 both predict scores for each of the sample candidates. Various types of LLMs and/or online model can be utilized. In some implementations, the LLM 105 is a decoder-only LLM. In some cases, supervised fine-tuning can be performed on a pre-trained LLM on a specific labeled dataset to adapt it to a particular task or domain, improving its performance in that context. In other cases, a pre-trained LLM can be used to perform tasks without any additional fine-tuning or task-specific training, relying solely on its general knowledge and capabilities. In the depicted example, the LLM 105 is an SFT LLM, and the online model 106 is a search relevancy model.

The scores from the LLM 105 and the search relevancy model 106 are compared, and data analysis 304 is conducted. Large score differences indicate the models' performances were different. In some implementations, a score difference threshold is utilized to determine whether the data sample is informative. Generally, the more powerful LLM 105 has better knowledge and capabilities. When scores are mismatched, it indicates that the data sample is a difficult sample for the search relevancy model 106. In such cases—i.e., when the score difference is large—the pipeline 300 can prioritize such data samples. The data analysis can also analyze the proportion of over- and under-estimations, as well as the bad-case ratio among the selected cases. Once the cases to be annotated are identified, the data samples are annotated 220 and utilized for training of the search relevancy model 106.

The sections below provide discussion on example implementations using discrete parameters to compare performances of the various strategies described herein. In one example setup, data in the form of query-video pair are sampled from the impression log of an online search service for a social media platform. An evaluation dataset is provided, utilizing 26k randomly sampled data that is 30 days old. The search relevance model utilized is pretrained on 100 million advertisements and 200 million shopping multi-modal data on three tasks: ITC (Image-Text Contrastive), ITM (Image-Text Matching), and MLM (Masked Language Modeling). Then, 1.72M random-AL mix annotated data is used for strategy comparison. Among the training dataset, 1.06M samples are randomly selected from data that is 60 days old, and another 500k samples are randomly selected from data between 30 to 60 days old. The remaining 160k samples for each group are selected using different AL methods to compare the effectiveness of various strategies. This approach ensures that there is no data leakage into the evaluation set. All data selected by different strategies were manually annotated.

The remaining 160k samples are provided from various groups to determine effectiveness of the different strategies described herein. In this setup, four different groups were assessed: random, statistical AL, LSB, and LSB with LLM. The random group includes 160k randomly sampled data, serving as a baseline to demonstrate the effectiveness of AL in general. In the statistical AL group, the 160k data is selected using uncertain statistical AL strategies, including a least confident metric, a margin sampling metric, and an N-best sequence entropy metric. The statistical AL group serves as another baseline to demonstrate the effectiveness of the strategies described herein. The LSB group includes 130k randomly selected data from the statistical AL group and 30k LSB-kNN selected data, provided by retrieving the top k=3 nearest neighbors based on 10k seed bad cases and 1 million impression log candidates' CLS hidden embeddings. The LSB with LLM group includes 100k randomly selected data from the statistical AL group, 30k LSB-kNN selected data, and 20k LLM-selected cases based on zero-shot scores of the impression log's data. O-score binary mismatched cases were selected.

In the example setup, the backbone of the search relevance model employs a 12-layer VLMO-Albert, combined with a 3-layer MLP. The model integrates features from seven textual domains, including query, title, industry, OCR, app_name, landingpage_info, etc, and one multimodal patch embedding domain. Each text domain is tokenized with a maximum length of 80. The model is optimized by an Adam optimizer with a fixed learning rate of 4e-5 and a batch size of 64. A training takes up to 4 epochs and can be terminated earlier if the test accuracy stabilizes, on 4 NVIDIA A100-80 GB GPU.

To evaluate the offline performance of the model in the evaluation dataset, the following metrics are utilized. A weighted F1 score for a four-class classification task represents the average F1 score across all classes, weighted by the number of true instances in each class, ensuring that each class's contribution is proportional to its size in the dataset.

$$Weighted F 1 = \frac{{\sum }_{i = 1}^{C} ( {F 1}_{i} \cdot {True}_{i} )}{{\sum }_{i = 1}^{C} {True}_{i}} \qquad ( 7 )$$

A non-zero recall at various precision corresponds to the recall rate for the classification of whether the label is “completely irrelevant.” A score-3 Recall at various precision corresponds to the recall rate for the classification of whether the label is “highly relevant.”

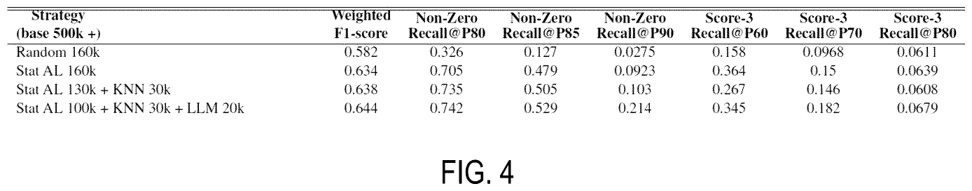

FIG. 4 shows a table comparing various data selection strategies. Each data selection strategy used 670k data points, including 500k shared data points. The remaining 160k data points differ depending on the data selection strategies. As shown, with the same amount of training data, the models trained on samples selected by active learning strategies significantly outperformed those trained on randomly selected samples. By replacing a portion of the statistical AL data with data selected by the LSB, both the non-zero recall rate and the weighted F1 score showed improvement. This indicates that the LSB-kNN strategy can further enhance the quality of training data compared to stat AL, likely because the data selected by the LSB compensates for some informational gaps. By further replacing 20k of the statistical AL data with data selected by an LLM, the evaluation metrics improved further. Overall, when mixed with statistical AL, the LSB and LLM strategies can further improve model performance using the same amount of training data.

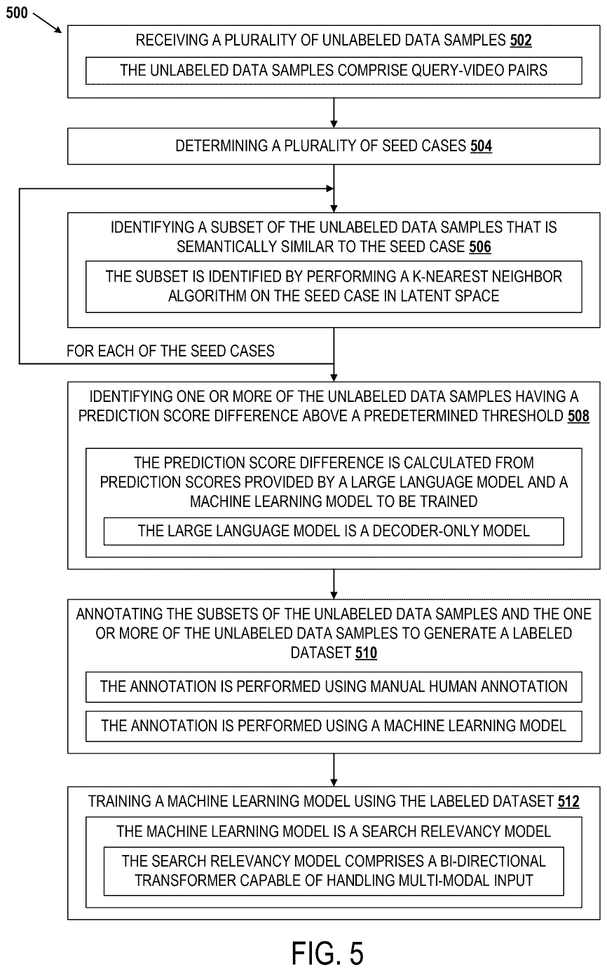

FIG. 5 shows a process flow diagram of an example method 500 for implementing sample broadening using large language model-based filtering to expand active learning strategies. The method 500 described herein relates to the training process of a machine learning model. The method 500 includes, at step 502, receiving a plurality of unlabeled data samples. The unlabeled data samples can include various types of content and be of various formats. In some implementations, the unlabeled data samples comprise query-video pairs. The unlabeled data samples can be provided from various sources. In some implementations, the unlabeled data is provided through an impression log recording live data for an online search system. In further implementations, the data is live data from a social media platform.

The method 500 includes, at step 504, determining a plurality of seed cases. Seed cases can be determined in various ways. For the purposes of this disclosure, cases, data samples, data points, and pairs may be used interchangeably. Generally, seed cases are selected from annotated data pairs that are identified as “bad” cases. “Bad” refers to a discrepancy in the model's predicted score and the data's annotation. The seed bad cases can be selected from a pool of annotated data pairs. In some implementations, the pool of annotated data pairs are data that have recently been annotated by the current process in a previous iteration. For example, data pairs selected for annotation from the previous day may serve as an initial pool. Various criteria can be implemented for selecting bad cases. In some implementations, seed cases are identified as a predetermined number of cases from the pool of annotated data pairs with the largest discrepancy between annotations and model predictions. Any number of seed cases may be utilized. In some implementations, approximately 10,000 seed cases are selected. In other implementations, approximately 20,000 seed cases are selected.

The method 500 includes, at step 506, for each of the seed cases, identifying a subset of the unlabeled data samples that is semantically similar to the seed case. The subset can be identified in various ways. In some implementations, the subset is identified by performing a k-nearest neighbor algorithm on the seed case in latent space to find semantically similar cases. Through the kNN algorithm, the method 600 selects one or more of the unlabeled data samples to be included in the subset based on their latent embeddings and their similarity to the latent embeddings of the seed case. In some implementations, the kNN algorithm ranks and selects K of the unlabeled data samples based on the ranking. Any number K can be used. In some implementations, K=3, and three data samples are identified for each of the seed cases.

The method 500 includes, at step 508, identifying one or more of the unlabeled data samples having a prediction score difference above a predetermined threshold. The prediction score difference can be calculated in various ways. In some implementations, a prediction score difference for a given unlabeled data sample is calculated from a prediction score of the given unlabeled data sample provided by a LLM and a prediction score of the given unlabeled data sample provided by a machine learning model, such as an online model. The prediction score difference can be calculated, for example, by comparing the difference between the two prediction scores. In some implementations, the prediction score difference is an absolute value of the mathematical difference between the two prediction scores. The LLM and machine learning model can be implemented in various ways. In some implementations, the machine learning model includes a search relevancy model or a content understanding model. Various types of LLM architectures can be utilized. The LLM can be zero-shot or may be fine-tuned. In some implementations, the LLM includes a decoder-only model.

The method 500 includes, at step 510, annotating the subsets of the unlabeled data samples (identified in step 506) and the one or more of the unlabeled data samples (identified in step 508) to generate a labeled dataset. The annotation can be performed in various ways. In some implementations, the filtered subsets of unlabeled data samples are annotated through manual human labeling. Additionally or alternatively, the filtered subsets of unlabeled data samples can be annotated through automated means, such as using another machine learning model.

The method 500 includes, at step 512, training the machine learning model using the labeled dataset. The machine learning model to be trained can be any type of machine learning model. In some implementations, the machine learning model is a search relevancy model. In further implementations, the search relevancy model includes a bi-directional transformer capable of handling multi-modal input. For example, the model can be configured to process query-video pairs.

The method 500 described herein provides an example process for performing LLM-based filtering for sample broadening. As can readily be appreciated, certain steps in the method 500 can be omitted or altered while still achieving LLM-based filtering. For example, in some implementations, step 508 is performed independently on a batch of unlabeled data pairs. Pairs satisfying the predetermined threshold are selected for labeling and utilized for training.

Traditional active learning methods, such as least confidence, margin sampling, and entropy-based approaches, rely on the statistical confidence of model prediction scores, which can result in the loss of semantic information or the neglect of high-confidence wrong predict cases. The kNN-based latent space broadening method described herein addresses these shortcomings by expanding the pool of candidates for active learning and integrating LLM-based differential selection to provide a candidate sampling process capable of generalization to untrained content and entities. This approach improves the model's performance across both low-confidence and high-confidence samples, enhancing its overall effectiveness and robustness.

In some embodiments, the methods and processes described herein may be tied to a computing system of one or more computing devices. In particular, such methods and processes may be implemented as a computer-application program or service, an application-programming interface (API), a library, and/or other computer-program product.

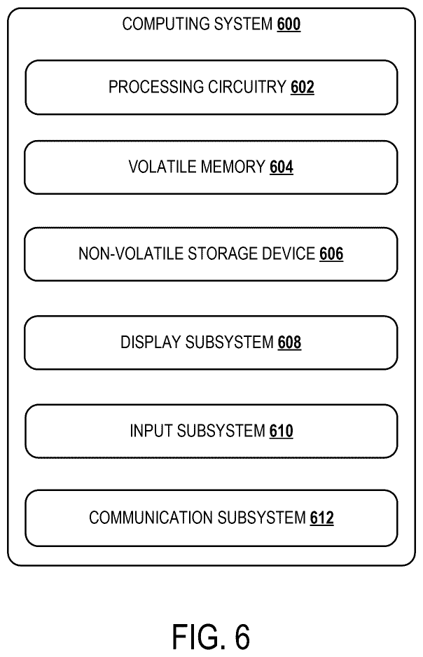

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 6. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry 602 includes a logic processor that can be implemented with one or more physical devices configured to execute instructions. For example, the processing circuitry 602 may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The processing circuitry 602 may include one or more physical processors configured to execute software instructions. Additionally or alternatively, the processing circuitry 602 may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry 602 optionally may be distributed among two or more separate devices, which may be remotely located and/or configured for coordinated processing. Aspects of the processing circuitry 602 may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the processing circuitry 602 to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program—and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One example includes a computing system for implementing an active learning strategy on a machine learning model, the computing system comprising: processing circuitry and memory storing instructions that, when executed, cause the processing circuitry to: receive a plurality of unlabeled data samples; determine a plurality of seed cases; for each of the seed cases, identify a subset of the unlabeled data samples that is semantically similar to the seed case; identify one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model; annotate the subsets of the unlabeled data samples and the one or more of the unlabeled data samples to generate a labeled dataset; and train the machine learning model using the labeled dataset. In this example, additionally or alternatively, the LLM comprises a decoder-only model. In this example, additionally or alternatively, the LLM comprises a zero-shot LLM or a supervised fine-tuned LLM. In this example, additionally or alternatively, the prediction score difference for the given unlabeled data sample is an absolute value of a mathematical difference between the prediction score of the given unlabeled data sample provided by the LLM and the prediction score of the given unlabeled data sample provided by the machine learning model. In this example, additionally or alternatively, the machine learning model is a search relevancy model. In this example, additionally or alternatively, the search relevancy model comprises a bi-directional transformer capable of handling multi-modal input. In this example, additionally or alternatively, the multi-modal input comprises query text and video frames, and wherein the plurality of unlabeled data samples comprises query-video pairs. In this example, additionally or alternatively, the search relevancy model is an online model implemented on a social media platform. In this example, additionally or alternatively, for each of the seed cases, identifying the subset of the unlabeled data samples that is semantically similar to the seed case comprises: performing a k-nearest neighbor algorithm on the seed case in latent space to identify the subset of the unlabeled data samples. In this example, additionally or alternatively, the plurality of seed cases is determined from a pool of annotated data samples based on discrepancies between annotations and model predictions.

Another example includes a method for implementing an active learning strategy on a machine learning model, the method comprising: receiving a plurality of unlabeled data samples; determining a plurality of seed cases; for each of the seed cases, identifying a subset of the unlabeled data samples that is semantically similar to the seed case; identifying one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model; annotating the subsets of the unlabeled data samples and the one or more of the unlabeled data samples to generate a labeled dataset; and training the machine learning model using the labeled dataset. In this example, additionally or alternatively, the LLM comprises a decoder-only model. In this example, additionally or alternatively, the LLM comprises a zero-shot LLM or a supervised fine-tuned LLM. In this example, additionally or alternatively, the prediction score difference for the given unlabeled data sample is an absolute value of a mathematical difference between the prediction score of the given unlabeled data sample provided by the LLM and the prediction score of the given unlabeled data sample provided by the machine learning model. In this example, additionally or alternatively, the machine learning model is a search relevancy model. In this example, additionally or alternatively, the search relevancy model comprises a bi-directional transformer capable of handling multi-modal input. In this example, additionally or alternatively, the multi-modal input comprises query text and video frames, and wherein the plurality of unlabeled data samples comprises query-video pairs. In this example, additionally or alternatively, the search relevancy model is an online model implemented on a social media platform. In this example, additionally or alternatively, for each of the seed cases, identifying the subset of the unlabeled data samples that is semantically similar to the seed case comprises: performing a k-nearest neighbor algorithm on the seed case in latent space to identify the subset of the unlabeled data samples.

Another example includes a non-transitory computer-readable medium storing a computer-readable program including instructions that, when executed by processing circuitry, causes the processing circuitry to: receive a plurality of unlabeled data samples; determine a plurality of seed cases; for each of the seed cases, identify a subset of the unlabeled data samples that is semantically similar to the seed case; identify one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model; annotate the subsets of the unlabeled data samples and the one or more of the unlabeled data samples to generate a labeled dataset; and train the machine learning model using the labeled dataset.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for implementing an active learning strategy on a machine learning model, the computing system comprising:
processing circuitry and memory storing instructions that, when executed, cause the processing circuitry to:
receive a plurality of unlabeled data samples;
determine a plurality of seed cases;
for each of the seed cases, identify a subset of the unlabeled data samples that is semantically similar to the seed case;
identify one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model;
annotate the subsets of the unlabeled data samples and the one or more of the unlabeled data samples to generate a labeled dataset; and
train the machine learning model using the labeled dataset.

2. The computing system of claim 1, wherein the LLM comprises a decoder-only model.

3. The computing system of claim 2, wherein the LLM comprises a zero-shot LLM or a supervised fine-tuned LLM.

4. The computing system of claim 1, wherein the prediction score difference for the given unlabeled data sample is an absolute value of a mathematical difference between the prediction score of the given unlabeled data sample provided by the LLM and the prediction score of the given unlabeled data sample provided by the machine learning model.

5. The computing system of claim 1, wherein the machine learning model is a search relevancy model.

6. The computing system of claim 5, wherein the search relevancy model comprises a bi-directional transformer capable of handling multi-modal input.

7. The computing system of claim 6, wherein the multi-modal input comprises query text and video frames, and wherein the plurality of unlabeled data samples comprises query-video pairs.

8. The computing system of claim 5, wherein the search relevancy model is an online model implemented on a social media platform.

9. The computing system of claim 1, wherein, for each of the seed cases, identifying the subset of the unlabeled data samples that is semantically similar to the seed case comprises:
performing a k-nearest neighbor algorithm on the seed case in latent space to identify the subset of the unlabeled data samples.

10. The computing system of claim 1, wherein the plurality of seed cases is determined from a pool of annotated data samples based on discrepancies between annotations and model predictions.

11. A method for implementing an active learning strategy on a machine learning model, the method comprising:
receiving a plurality of unlabeled data samples;
determining a plurality of seed cases;
for each of the seed cases, identifying a subset of the unlabeled data samples that is semantically similar to the seed case;
identifying one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model;
annotating the subsets of the unlabeled data samples and the one or more of the unlabeled data samples to generate a labeled dataset; and
training the machine learning model using the labeled dataset.

12. The method of claim 11, wherein the LLM comprises a decoder-only model.

13. The method of claim 12, wherein the LLM comprises a zero-shot LLM or a supervised fine-tuned LLM.

14. The method of claim 11, wherein the prediction score difference for the given unlabeled data sample is an absolute value of a mathematical difference between the prediction score of the given unlabeled data sample provided by the LLM and the prediction score of the given unlabeled data sample provided by the machine learning model.

15. The method of claim 11, wherein the machine learning model is a search relevancy model.

16. The method of claim 15, wherein the search relevancy model comprises a bi-directional transformer capable of handling multi-modal input.

17. The method of claim 16, wherein the multi-modal input comprises query text and video frames, and wherein the plurality of unlabeled data samples comprises query-video pairs.

18. The method of claim 15, wherein the search relevancy model is an online model implemented on a social media platform.

19. The method of claim 11, wherein, for each of the seed cases, identifying the subset of the unlabeled data samples that is semantically similar to the seed case comprises:
performing a k-nearest neighbor algorithm on the seed case in latent space to identify the subset of the unlabeled data samples.

20. A non-transitory computer-readable medium storing a computer-readable program including instructions that, when executed by processing circuitry, causes the processing circuitry to:
receive a plurality of unlabeled data samples;
determine a plurality of seed cases;
for each of the seed cases, identify a subset of the unlabeled data samples that is semantically similar to the seed case;
identify one or more of the unlabeled data samples having a prediction score difference above a predetermined threshold, wherein the prediction score difference for a given unlabeled data sample is determined by comparing a prediction score of the given unlabeled data sample provided by a large language model (LLM) with a prediction score of the given unlabeled data sample provided by the machine learning model;
annotate the subsets of the unlabeled data samples and the one or more of the unlabeled data samples to generate a labeled dataset; and
train the machine learning model using the labeled dataset.
